(19) United States
(12) Patent Application Publication
(10) Pub. No.: US 2009/0327244 A1
(43) Pub. Date: Dec. 31, 2009

(54) Method, process, apparatus and system for peer-to-peer media sharing, transmissions and distributions

(76) Inventor: Dharmarus Rizal, Mountain View, CA (US)

Correspondence Address: Dharmarus Rizal, 100 N. Whisman Road #821, Mountain View, CA, 94043, US

(21) Appl. No.: 12/456,582

(22) Filed: Jun. 17, 2009

Related U.S. Application Data
(60) Provisional application No. 61/075,319, filed on Jun. 24, 2008.

(51) Int. Cl. G06F 15/16; G06F 21/00; G06F 17/30

(52) U.S. Cl. 707/3; 709/204; 726/4; 707/104.1; 709/232; 707/E17.009; 707/E17.014

(57) ABSTRACT

The current invention describes method, process, apparatus and system for peer-to-peer media sharing, transmissions and distributions for digital personal media. The current invention is designed to facilitate highly scalable and efficient media distributions for high quality personal media. A purpose of the current invention is to simplify and enhance high quality media sharing experience by providing an integrated networked system for peer-to-peer media delivery over wide area network (WAN) such as the Internet and media distributions in local area network (LAN). Another purpose of the current invention is to provide a safe and secure platform that provides media senders with means to manage authorized recipients and media recipients with means to control media contents to receive.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

With technology advances in consumer digital video and digital camera devices, digital photos and videos have become the medium of choice in capturing, preserving and sharing personal memories, events and moments. Life events such as birthdays, baby's first steps, school arts and athletic events, weddings, graduations, class reunions, vacation trips, holidays, religious celebrations and many others are increasingly captured in digital photos and videos all over the world. Personal media recordings have developed into a global social culture in today's digital age.

High quality consumer electronics devices continue to globally penetrate mainstream markets. Market and technology growths in four main areas below are essential for user experience in high quality personal media:

High Definition Display

High Definition Video and Image Capture

High Capacity Data Storage

Home Networking Technology

The growth in the four main areas above creates new demands for applications in high quality personal media.

High definition digital television sets (HDTV) allows digital media such as photos and videos to be rendered and displayed in high resolution. For example, a digital high definition television set with 1920×1080 progressive scan (1080p) display capability can display 2,073,600 pixels. Such high resolution capability allows significant increase in display size (26, 32, 37, 50 inches or above in diagonal size) to deliver life-like quality images for human eyes to detect at associated proper viewing distances. Rich details in photos and videos such as facial expressions as well as landscapes' color and texture can be easily and clearly seen in large size by human eyes. As a result, such high quality images greatly enhance the experience of “being there” for their viewers.

High definition video and image capturing devices have increasingly been improved in image quality. Currently available consumer digital camcorder devices have high definition capturing capability in native 720 or 1080 format. And consumer digital cameras available in the market can capture digital pictures in 8, 10 or 12 mega pixels format. As a result, such image recording devices allow consumers to electronically capture and preserve life events in rich details.

High quality photos and high definition videos contain a lot of data. For example, compressed 10 mega pixel photos may contain about 3 to 4 megabytes of data. And one hour of compressed high definition videos might contain about 6 to 8 gigabytes of data. As a result, large data storage devices are needed to stored such high quality photos and videos. Rapid growth in personal computer market significantly drives advancement in storage capacity. The cost per storage capacity has been significantly lowered over the years. High capacity hard disk drives (HDD) such as 250 GB or 320 GB hard disk drive are commonly available in entry-level personal computers. Such high capacity storage devices allow consumers to economically store and preserve their collections of digital media such as digital photos and videos. However, distributions of such large amount of data may still be costly due to network security and bandwidth restrictions.

Home networking technology has been significantly growing. As market adoption for personal computers and other network-enable devices such as game consoles and smart phones has been rapidly increasing over the years, deployments of home networks whether wired or wireless have also been significantly growing. Furthermore, many consumer electronics devices (such as personal computers, media adapters, game consoles, set-top boxes, digital television, etc) implement media delivery protocols (such as UPnP, Jini, etc) that can be deployed over wired network infrastructure (such as ethernet, power lines, optical lines, coaxial cables, etc) and/or wireless network infrastructure (such as IEEE 802.11a/b/g/n, bluetooth, etc). Such media delivery protocols are designed for device interoperability in local area networks. Due to network security, performance efficiency and scalability, it would be difficult to deploy such media delivery protocols in their purest forms for media sharing over wide area network such as the Internet.

Sharing, transmissions and distributions of high quality personal media such as high definition photos and videos are costly as well as difficult to do and time consuming. Furthermore, the lack of an integrated ecosystem causes a poor user experience in viewing, organizing and sharing of high definition personal media for our increasingly digital lifestyle. For example, getting different devices to interoperate is a complex task for most users, thereby preventing basic functionalities such as viewing personal media over a home network in digital television sets.

Personal media may contain contents that are personal in nature. Hence, sharing and distribution platform for such personal media must incorporate effective mechanisms to securely manage and control authorized recipients for such personal media. Conventional media publishing systems may not be suitable for the purpose of sharing and distributing personal media content. Furthermore, such sharing and distribution platform must also provide means for media sharing recipients to control media contents that they are willing to receive.

### BRIEF SUMMARY OF THE INVENTION

The current invention describes method, process, apparatus and system for peer-to-peer media sharing, transmissions and distributions for digital personal media. The current invention is designed to facilitate highly scalable and efficient media distributions for high quality personal media. A purpose of the current invention is to simplify and enhance high quality media sharing experience by providing an integrated networked system for peer-to-peer media delivery over wide area network (WAN) such as the Internet and media distributions in local area network (LAN). Another purpose of the current invention is to provide a safe and secure platform that provides media senders with means to manage authorized recipients and media recipients with means to control media contents to receive.

### BRIEF DESCRIPTION OF THE SEVERAL VIEWS OF THE DRAWING

FIG. 1: diagram of system overview

FIG. 2: diagram of example of relationships between user accounts, client software and computing devices.

FIG. 3: diagram of direct peer-to-peer connection and relay peer-to-peer connection

FIG. 4: diagram of peer-to-peer connections between a client software and a number of other client software

FIG. 5: diagram of example of two client software and their registered media files

FIG. 6: diagram of example of media sharing system and processes

FIG. 7: diagram of example result of search operations for receiving client software

FIG. 8: flowchart of process of constructing peer-to-peer connections

FIG. 9: diagram of example of data streaming process

FIG. 10: diagram of client software

FIG. 11: diagram of system for integration of peer-to-peer media transmissions with rendering operations in local area network

FIG. 12: diagram of example of media categorizations

### DETAILED DESCRIPTION OF THE INVENTION

The current invention describes method, process, apparatus and system for peer-to-peer media sharing over the Internet for electronic devices. The system consists of server system and distributed client software that allow highly scalable and efficient media sharing. Although FIG. 1 shows a particular embodiment of the system, other variations of the embodiments are also possible that will be described in this document.

As shown in FIG. 1, a typical house such as House 1 (200) may employ a router/firewall device (240). Such router/firewall device (240) may be used to protect network-enabled devices that are connected in a local area network from outside intruders. Another purpose for such router/firewall device (240) may be to share an Internet access connection from an Internet service provider (ISP) among multiple devices.

Another purpose for such router/firewall device (240) may be to create a local area network or LAN (241) that allows network-enabled devices such as personal computers and media adapters to communicate with each other within such house's LAN (241).

As shown in FIG. 1, client software (202) is an application program that is executed by computing device (201) such as laptop computer, desktop computer, media server computer, portable media device, smart phone or other similar computing devices. Computing device (201) is a device that has means for data processing and network communications that may include processor, volatile memory devices, non-volatile memory devices, wired and/or wireless network interfaces, and/or other standard data input and output capabilities. Such client software (202) is capable of receiving media files such as photos, video and music from other computing devices that run such client software (such as Client Software 302) over wide area network and/or local area network. Such client software (202) may also have media capturing capabilities to transfer media files from image capturing devices (210) such as digital cameras or digital camcorders to such computing device's (201) memory devices. In another embodiment, image capturing devices (such as web camera or embedded camera) may be connected to (through wired and/or wireless means) or built-into such computing device (201) to directly store captured images into such computing device's (201) memory devices. In another embodiment, external data storage devices such as external hard disk drives or solid state drives may also be connected to such computing device (201) using wired connections or wireless connections. Such external data storage devices that may provide additional data storage capacities may also contain media files that can be accessed by such client software (202).

Such media files that are received by such client software (202) of such computing device (201) may also be transferred to portable media players (230) to enhance data mobility for such media files. Such portable media player (230) is a small-sized device that has means for portable data processing that may include processor, volatile memory devices, non-volatile memory devices, portable power devices and/or other standard data input and output capabilities. Such portable media player (230) is capable of rendering such media files. In some cases, such media files may be converted to smaller media files that may be more suitable for such portable media player's (230) limited capacities in display size, memory devices and processor.

Such Client software (202) has media server capabilities in such local area network (241). Such media server capabilities will be described in more details in later sections of this document. Such media server capabilities provide such client software (202) with means to distribute media files such as photos, videos and music to other network-enabled devices such as media adapter (220) in such local area network (241). Such client software (202) may facilitate such distributions of such media files using standard data delivery protocols including HTTP, TCP, UDP, UPnP, Jini and/or other protocols capable of transporting media files.

Media adapter (220) has means for rendering user interfaces and media files to be displayed or played in digital television set (221). Although FIG. 1 shows such digital television set (221), other electronic media devices may also be used including analog television set, CRT display set, computer monitor or other devices that are capable of displaying or playing such media files through such media adapter (220). Just as such computing device (201) is part of such local area network (241), such media adapter (220) is also a network-enabled device that is configured to be part of such local area network (241). Hence, such media adapter (220) has means for network communications using wired and/or wireless connections. Such client software (202) implements network protocols commonly understood to such media adapter (220) to allow both devices to discover each other in such local area network (241). Such discovery mechanism may be necessary to allow such media adapter (220) to find such media server of such client software (202) for media distributions in such local area network (241).

Consequently, using user interfaces that are rendered by such media adapter (220) in such digital television set (221) a user can navigate, browse, search and fetch such media files that are served by such media server of such client software (202). Using such user interfaces, such user may request such media server to transmit selected media files such as photos, videos and/or music to be played or watched. Such media server of such client software (202) may then transmit contents of such selected media files over such local area network (241) to such media adapter (220) which renders contents of such selected media files to be displayed or played in such digital television set (221). Such a system may provide additional flexibility that allows such user to play or watch such media files in one location (such as the living room where such digital television set and such media adapter may reside) while such media server of such client software (202) may reside in another location reachable within such local area network (241).

Such media adapter (220) may also have means for storing data in internal and/or external storage devices. In such a case, such media files that are transmitted by such media server of such client software (202) may be stored in such media adapter's (220) storage devices. In such a case, such media adapter (220) may subsequently render such media files from its storage devices hence eliminating the necessity for network transmissions from such media server of such client software (202).

In another embodiment, the functionality of media adapter (220) may be built into the digital television set (221). Yet in another embodiment, the functionality of client software (202) may be built into the digital television set (221), hence eliminating the need for the media adapter (220). In such alternative embodiments above, the digital television set (221) would be equipped with necessary computing resources that may include processor, memory devices and network interfaces.

FIG. 1 also shows House 2 (300) that may also have a router/firewall device (340) to create a local area network (341). The same as House 1 (200), House 2 (300) may also have a computing device (301), client software (302), image capture devices (310), portable media players (330), media adapters (320, 322) and digital television sets (321, 323). As shown in FIG. 1, House 2 (300) is a counter part of House 1 (200) for sharing media files over the Internet (800). As shown in FIG. 1, House 2 (300) may have multiple media adapters (320, 322) to obtain media files from such media server of such client software (302) over such local area network (341). In such a case, a media adapter (320) may receive media files from such client software (302) to be rendered in a digital television set (321), while another media adapter (322) may receive media files from such client software (302) to be rendered in another digital television set (323).

Server system (100) as shown in FIG. 1 centrally manages all distributed client software. Such server system (100) is designed for high availability system. Such server system (100) may be implemented with appropriate redundancies and hosted in highly reliable data centers. Server system (100) may consist of two types of servers such as database server (101) and control server (102). Both database server (101) and control server (102) are software applications that can be executed in multiple physical server computers in load-balanced or cluster arrangement to allow scalability and reliability. Although, FIG. 1 shows two distributed client software (202, 302) for simplicity of description, the server system (100) may manage a large number of distributed client software.

Database server (101) manages information associated with user accounts and distributed client software. Database server (101) also has means to process client software's requests and send responses to client software. A Database server (101) also has means to send messages in electronic forms via network systems known to the art including email systems, mobile messaging systems, fax systems and/or paging systems.

Such client software is registered to such database server (101) with unique peer identification information (peerID). Such peerID of such client software allows such database server (101) to globally identify a particular entity of such distributed client software. Such client software may also be assigned to a user account as the owner of such client software. Such user account is registered to such database server (101) with unique user identification information (userID). Such client software registration and user account registration may be done in data formats that are understood by such database server (101) using communication means over wide area networks.

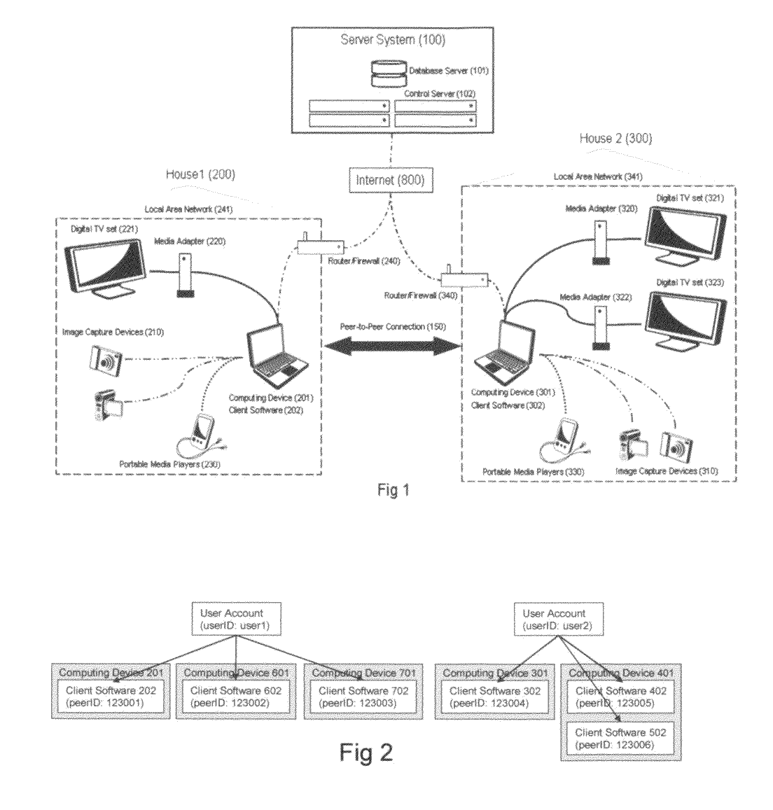

FIG. 2 shows an example of relationships between user accounts, client software and computing devices. A user account may own multiple client software that may be installed in different computing devices. In some instances, multiple client software may also be installed in the same computing device. An owner has administrative control over all of his or her client software.

Control server (102) is configured to allow communications with all distributed client software. Such client software needs to be authenticated by such database server (101) using such peer identification information and other verification means such as user identification information, password and/or other verification data that are stored in such database server (101). Such authentication mechanisms are necessary to ensure that such client software is genuine for security purposes. Such security measures are needed to allow media files to be securely distributed among authenticated client software. After such client software (202) is authenticated by such database server (101), such client software (202) may then communicate with such control server (102).

Such database server (101) may also manage network information associated with such client software (202). Such network information may include geographic location information (such as latitude, longitude, county/district, city, state/province or country) and/or network service providers. Such network information may be automatically detected by such database server (101) based on such client software's network address in a manner known to the art. In another mechanism, such client software (202) may also explicitly provide such network information to such database server (101). Such client software (202) may obtain such network information that is specified by user. If such computing device (201) that executes such client software (202) is equipped with means to access global positioning systems (GPS), such client software (202) may also automatically obtain such network information from such global positioning systems.

FIG. 1 shows peer-to-peer connection (150) between client software (for example: between client software (202) and client software (302)). Such peer-to-peer connection provides means for two-way data communications between such client software. Such data communications through such peer-to-peer connection may also be encrypted to ensure privacy in data transmissions. Such peer-to-peer connections may be constructed among associated client software which need to communicate with one another. For example, such peer-to-peer connections may be constructed among associated client software which are engaged in media sharing as data senders (source client software) and data receivers (receiving client software).

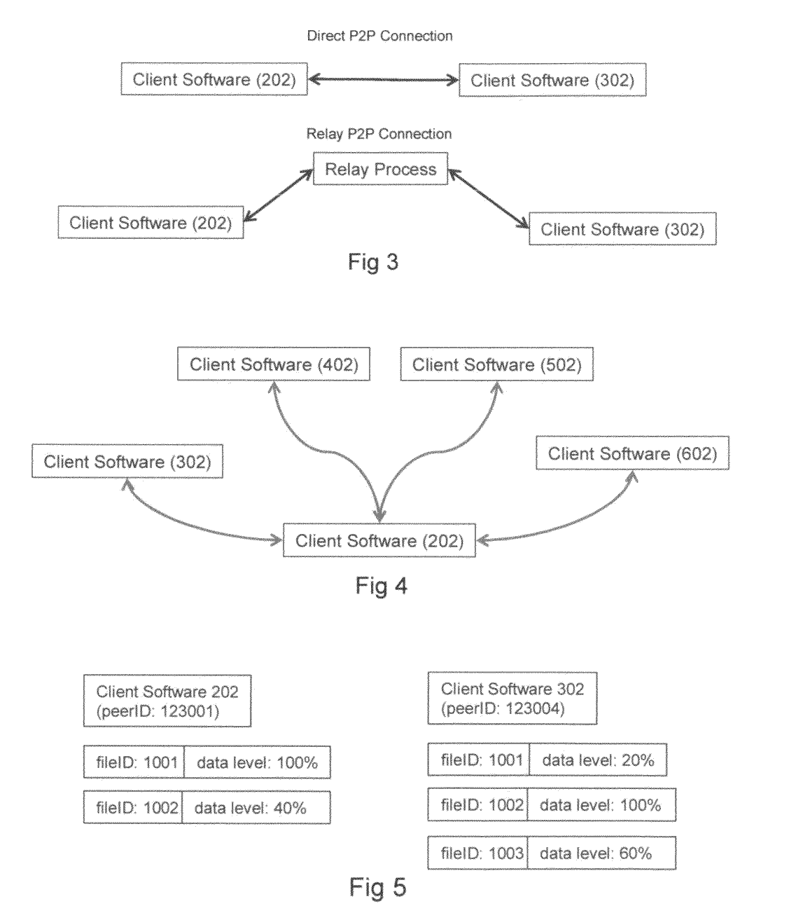

Two types of peer-to-peer connections may be constructed between such client software: direct peer-to-peer connection and relay peer-to-peer connection. FIG. 3 shows a direct peer-to-peer connection where associated client software (for example: client software (202) and client software (302)) can communicate and transmit data directly to each other. Such control server (102) may assist in the constructions of such direct peer-to-peer connections between such client software in a manner known to the art.

In same cases, due to firewall or other security restrictions, such direct peer-to-peer connection between such client software can not be established. In such a case, relay peer-to-peer connection is used to facilitate data communications between such client software using a relay processor. Such control server (102) may be used to relay data transmissions between such client software. In a case of relay peer-to-peer connection as shown in FIG. 3, data from sending client software is first transmitted to such relay processor where receiving client software may obtain such data from.

Such client software may establish a number of such direct peer-to-peer connections and/or such relay peer-to-peer connections. FIG. 4 shows such client software (202) that establishes a number of peer-to-peer connections with other client software (302, 402, 502, and 602).

Constructions of such peer-to-peer connections may be based on transactions of media sharing requests by media senders and media sharing acceptances by media receivers. Next section describes such media sharing transactions and processes.

Media sharing transactions and processes are managed by such database server (101) that provides central transaction processing for media sharing among all client software. All media files that are being shared are registered to such database server (101). Each of such registered media file is assigned with globally unique file identification information (fileID) by such database server (101). A user who initially registers an unregistered media file may be designated as the originator or the owner of such media file. Hence, database server (101) may identify an owner userID as part of media properties associated with such registered media file. Such database server (101) may also identify media type information (such as video, photo or music) as part of media properties associated with such registered media file. Such originator or such owner of such media file may also include title information, description, tag information and/or caption information as part of media properties of such media file to be registered to such database server (101). Such title information, description, tag information and/or caption information associated with such media file may only be edited by such file owner and other users who have been authorized by such file owner. Such media properties may also include notes or comments associated with such media file that are registered to such database server (101). Such file owners and all users who are authorized to receive such media files may submit notes or comments associated with such media files to be registered to such database server (101). Such media properties of such media files may be received by such file owners and all users who are authorized to receive such media files. Distributions of such media properties of such media files are facilitated by such database server (101) for such file owners and all such authorized users upon creation, addition, modification or deletion of such media properties.

In addition to having a globally unique fileID, a media file may also have a parentFileID registered to such database server (101). Such media file that has a parentFileID is a derivative from a parent media file that is identified by such parentFileID. Such parentFileID allows such database server (101) to associate media properties of such parent media file with such derivative media files. Such media properties may include such owner identification information, media type information, title information, description, tag information, caption information and notes/comments described above.

Such derivative media file may also have derivative statuses registered to such database server (101). Such derivative statuses may indicate derivative operations that are performed to such derivative media file. Such derivative operations may be performed by any such client software (202) that has such parent media files and computational means to perform such derivative operations. Such derivative operations may include down sampling, quality reduction, size reduction, enhancement, special effects and other common editing operations. For example, a derivative media file may be a lower resolution version that is derived from a parent media file such as: 480p derivative video file derived from 1080p parent video file or 1 megapixel derivative photo file derived from 12 megapixel parent photo file.

To identify media data sources, such database server (101) also manages information associated with such client software (202) and their associated registered media files. Such database server (101) may also record the amount of available data or data level that such client software (202) has for such registered media file. Such data level provides a mechanism to analyze the amount of data that such client software (202) can provide as a media source for such registered media file. FIG. 5 shows an example of two client software (202 and 302) and their registered media files.

As shown in FIG. 5, a particular registered media file with fileID 1001 is stored in multiple client software namely: client software 202 (peerID: 123001) and client software 302 (peerID 123004). Client software 202 has complete content or data level of 100% for such media file while client software 302 has data level of 20% for such media file. Such database information above identifies such client software as media sources and their associated data levels for such registered media file. Although, the example in FIG. 5 shows available data or data level in content percentage of such registered media file, other information types that may indicate available data (such as in bytes, kilobytes, megabytes or gigabytes of available data versus total data size) for such registered media file at such client software may also be used.

To share media files, a user specifies a media sharing request which may contain the following essential information:

Sender Identification Information (sender userID)

List of Recipient Identification Information

List of Selected Media Files for Sharing (a list of registered fileIDs)

Sender identification information is userID of the sender who creates such media sharing request.

List of recipient identification information specifies authorized recipients for receiving such shared media files. Such recipient identification information may be specified in the form of recipient's userID, recipient's email address, recipient's phone number or other information that can identify a valid user. Hence, such valid user is identified by such recipient identification information that is part of user account data that is deemed acceptable through verification process by such database server (101). In contrast to a publishing system, the current invention systematically enforces control of media file recipients as defined in such media sharing requests through authentication process of all such media sharing request recipients by such database server (101). Recipients who have not yet registered to such database server (101) may receive invitation messages from such database server (101) for registration and verification process to receive the associated media sharing request.

The media sharing request includes fileIDs of selected media files to share. Media files that have not been registered to such database server (101) may be registered by such client software which has access to such media files in accessible storage devices. In such a case, the user account that owns such client software may also be designated as the originator or the owner of such media files. Such client software may store such registered fileIDs and data storage locations of such storage devices for such media files in a local database.

The sender of such media sharing request may also include sharing subject and/or sharing message as part of such media sharing request. Such sharing subject and/or sharing message allow such sender to provide such authorized recipients with descriptions for such media sharing request.

After specifying such media sharing request, the sender of such media sharing request may submit such request to such database server (101) for processing. Submissions of such media sharing requests may be made in data formats that are understood by such database server (101) using communication means over wide area, network. Such media sharing requests may also be created and submitted from such client software. Other means of electronic data transmissions known to the art including web page submissions, email systems, mobile messaging systems, or fax systems may also be used to submit such media sharing requests to such database server (101).

Receiving such media sharing request, such database server (101) may store such media sharing request in appropriate data structures for processing. Such authorized recipients that have registered to such database server (101) may receive such media sharing request. For such registered recipients, such media sharing request may be received by all client software that are owned by such registered recipients' user accounts. In addition, such database server (101) may also send notification messages that may also contain such media sharing request, to such registered recipients via network systems known to the art including email systems, mobile messaging systems, fax systems and/or paging systems. Such notification messages may also provide such registered recipients with further instructions for accepting such media sharing request.

For such authorized recipients that have not yet registered, such database server (101) may send invitation messages to such non-registered recipients. Such database server (101) may send such invitation messages to such non-registered recipients via network systems known to the art including email systems, mobile messaging systems, fax systems and/or paging systems. Such invitation messages may include instructions for such non-registered recipients to create user account and register client software. By creating user account and registering client software with such database server (101) through a registration process using communication means over wide area network, a non-registered recipient becomes a newly-created registered recipient with her/his unique user identification information (userID). Such invitation messages may also include such media sharing request and verification code to further verify the validity of such newly-created registered recipients. Such verification code may be provided in the forms of randomly selected characters, words, phrases and/or numbers. Such verification code allows such database server (101) to verify such newly-created registered recipient to receive such media sharing request. Such verification code may be generated by such database server (101) as a globally unique code that can only be used once to verify a particular registered recipient to receive a particular media sharing request. A newly-created registered recipient may submit such verification code to such database server (101) using communication means over wide area network. After such database server (101) verifies such verification code, such newly-created registered recipient would be able to receive such media sharing request in the manner described in previous section of this document.

To accept a media sharing request, a registered recipient who receives such media sharing request may submit media sharing acceptance to such database server (101) using communication means over wide area network. Such media sharing acceptance may also identify one or more such client software that are owned by such registered recipient's user account for receiving such shared media files. Such media sharing acceptance may be submitted from client software that is owned by such registered recipient's user account. Other means of electronic data transmissions known to the art including web page submissions, email systems, mobile messaging systems, fax systems, or paging systems may also be used to submit such media sharing acceptance in data formats that are understood by such database server (101).

Such media sharing acceptance may also indicate that such one or more client software to be configured to automatically accept media sharing requests from such request sender. Hence, future media sharing requests from such trusted request sender may be automatically accepted by such one or more client software without explicit approval from such registered recipient. Such automatic acceptance configurations for such one or more client software may further simplify such media sharing process for such registered recipient.

Such automatic acceptance configurations may further include configuration settings that are based on certain data characteristics including media type information (such as photo, video and/or music), data sizes and/or keywords (from title, caption, tag information, description, notes/comments, geographic locations, media capture device type and/or other media information). For example, particular client software may be configured to automatically accept all video files shared by such trusted sender, while another client software may be configured to automatically accept all photo files shared by such trusted sender, yet while another client software may be configured to automatically accept all media files shared by such trusted sender. Such example shows multiple client software that are configured to automatically accept media sharing requests from a trusted sender. Such example also shows that such automatic acceptance configurations further include configuration settings that are based on media type information. Such registered recipients may also cancel such automatic acceptance configurations at any time by sending cancellation requests to such database server (101) via communications means over wide area network.

The above description explains such automatic acceptance configurations for one or more client software to automatically accept such media files that are shared by such trusted users. Similar mechanisms may also be utilized by such registered recipient to automatically reject media sharing requests from users that are not trusted by such registered recipient. Such registered recipient may submit such automatic rejection configurations that indicate such non-trusted user identification information to such database server (101) via communications means over wide area network. Hence, such database server (101) can automatically reject all media sharing requests from such non-trusted users to such registered recipient. Alternatively, such registered recipient may also submit such automatic rejection configurations to configure white list settings in such database server (101). Such white list settings contain user identification information of only trusted users from who such registered recipient may accept media sharing requests. Hence, if such white list settings are configured, such database server (101) will automatically reject all media sharing requests to such registered recipient from any users who are not defined in such white list settings. Such automatic rejection configurations above provide such registered user with means to control media contents that he or she would like to receive.

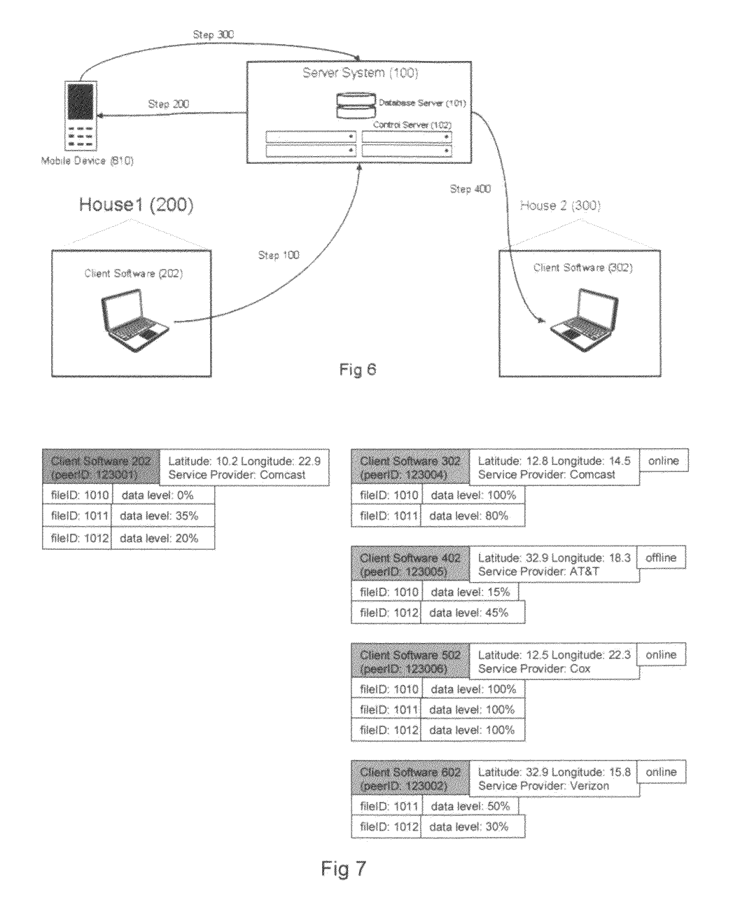

Media sharing system and processes described above provide location and time flexibilities for users to send media sharing requests, receive media sharing requests, and provide associated media sharing acceptance responses. FIG. 6 and the following explanation describe a simple example case for the purpose of description. User (A) who owns client software (202) would like to share media files with User (B). User (A) then creates a media sharing request that includes fileIDs of selected media files and the list of recipient identification information. In this example, such list of recipient identification information contains userID of the registered recipient User (B). In Step 100, User (A) submits such media sharing request from client software (202) located in House 1 to such database server (101) over wide area network. In Step 200, such database server (101) sends notification messages to User (B) using communication means over wide area network. At any time after Step 200, User (B) who is located in different location such as work location would be able to receive such media sharing request using a mobile computing device (810) such as a smart phone over wide area network.

In Step 300, at any time after receiving such media sharing request, User (B) may submit to such database server (101) a media sharing acceptance that identifies such client software (302) that is owned by User (B) for receiving such shared media files. In Step 400, using communication means over wide area network, such database server (101) sends commands for configurations of such client software (302) located in House 2 to receive such shared media files. The above example describes User (B) having flexibilities of location and time to receive a media sharing request in a location and time; and submit media sharing acceptance to start media receiving process at such client software (302) in another location and time. The above description explains system and processes for media sharing. Such system and processes for media sharing allow configurations of client software to receive such shared media files through transactions of such media sharing requests and such media sharing acceptances. Next section will describe system and processes for media content transmissions that are based on transactions that are executed in such system and processes for media sharing.

As described above, a media sharing acceptance is submitted by a registered recipient to such database server (101) in response to a media sharing request. Such media sharing acceptance also identifies one or more client software that are owned by such registered recipient to be configured to receive such shared media files. Such receiving client software receives from such database server (101) a list of selected media files for such receiving client software to receive. Such list of selected media files may be specified in the form of registered fileIDs. Such receiving client software is also equipped with a local database to permanently store such registered fileIDs in such local database's data structures. Such local database also manages the amount of available data or data level associated with such selected media files. Such local database may also manage information related to media sharing requests for such selected media files, which includes date information of sending, receiving or accepting of such media sharing requests as well as sender identification information, recipient identification information, sharing subjects and sharing messages of such media sharing requests.

Such receiving client software initiates the process of constructing peer-to-peer connections with other source client software that can be identified as potential data sources for receiving contents of such shared media files. Such receiving client software may request such database server (101) for information of source client software by providing such database server (101) with such list of selected media files in the form of registered fileIDs. Such database server (101) may then perform search operations to find such source client software that may have such shared media files. Such database server (101) may further indicate such source client software that are currently available online. Such online status of client software may be automatically detected by analyzing communication status between such client software and such control server (102). Such database server (101) may further indicate such source client software that have more file content or higher data level for such shared media files. Such database server (101) may further provide geographic distance information between such receiving client software and such source client software. Such geographic distance information may be derived by analyzing client software's latitude and longitude information that are obtained by such database server (101) in manners previously described. Such database server (101) may further provide network service provider information for such receiving client software and such source client software. Such database server (101) compiles and sends results of such search operations to such receiving client software.

FIG. 7 shows example results of such search operations for receiving client software (202). In such example results, such database server (101) identifies four source client software (302, 402, 502, and 602) that have such shared media files.

Such results of search operations allow such receiving client software to make intelligent decisions in selecting source client software that are available online with higher data levels to receive contents of such shared media files. Such source client software selection process may be designed to find source client software that can provide highest transmission performance at lowest transmission cost. Consequently, such source client software selection process may prioritize source client software that are geographically closer to such receiving client software. For certain geographic distance radius or locality (such as county/district, city, state/province or country), such source client software selection process may further prioritize such source client software that have the same network service provider as that of such receiving client software.

Constructions of peer-to-peer connections with such selected source client software may be initiated by such receiving client software. Such peer-to-peer connections are utilized for transmissions of media contents of such shared media files. Such receiving client software may continue to construct such peer-to-peer connections with such source client software until certain data transmission conditions are reached. Such data transmission conditions can be based on limiting factors. Such limiting factors may include total data transmission rate (bytes/sec), average data transmission rate per peer-to-peer connection (byte/sec/connection), maximum number of peer-to-peer connections.

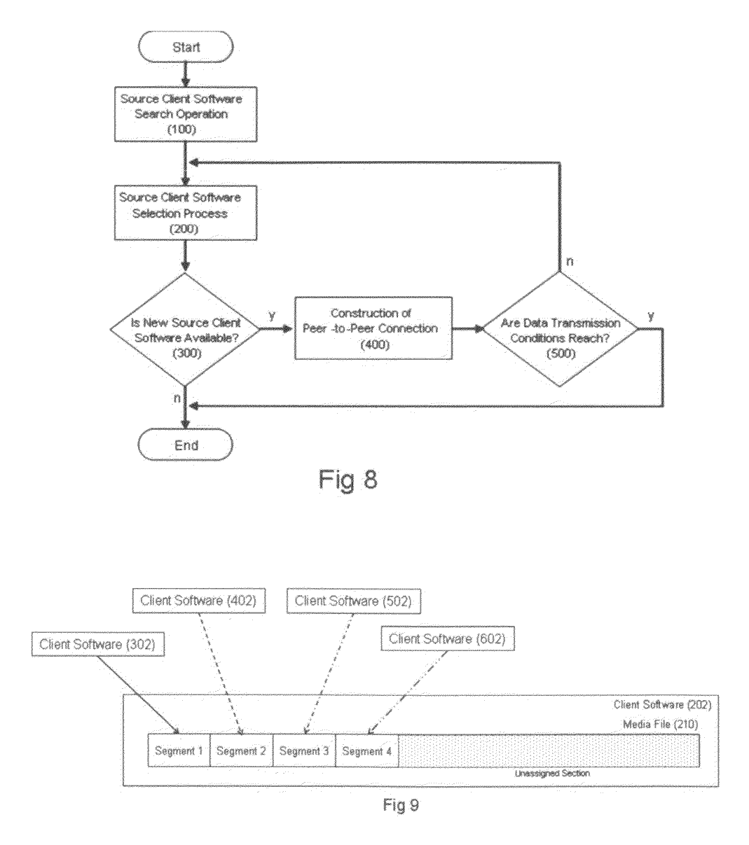

FIG. 8 shows the process for constructing such peer-to-peer connections. In step 100, such receiving client software requests such database server (101) to perform search operations to find source client software that may have such shared media files. In step 200, such receiving client software, performs source client software selection process to choose new source client software. If such new source client software is available (step 300), such receiving client software initiates construction of peer-to-peer connection (step 400) with such new source client software. In step 500, such receiving client software evaluates data transmission conditions. Such evaluation may be performed over a period of time to allow sufficient data collections for analysis of such data transmission conditions. If such data transmission conditions have not been reached, such receiving client software may repeat source client software selection process (step 200). As shown in FIG. 8, such process of constructing such peer-to-peer connections ends if either no new source client software is available or data transmission conditions are reached.

Data of such shared media files may be transmitted from a number of such source client software to such receiving client software using such constructed peer-to-peer connections. Such data transmissions may be performed in a manner of a streaming process, hence allowing such data of such shared media files to be rendered and viewed while such data transmissions are performed. Such data streaming process maximizes the length of continuous media data that can be rendered and viewed before such data streaming process is complete. Such advantage is particularly important for music and video files to allow such receiving client software to render or serve as much continuous media contents as soon as such data streaming process begins.

For explanation purposes, FIG. 9 shows an example of such data streaming process. In such example, receiving client software (202) establishes peer-to-peer connections with a number of source client software (302, 402, 502 and 602) to receive a shared media file (210). Such receiving client software (202) may divide such shared media file (210) into a number of segments. Each segment represents a section of such media file (210). Such segments are sequentially selected in a manner to allow data streaming. Such receiving client software (202) sends requests to such source client software to transmit such selected segments. In such example, such receiving client software (202) send requests to such source client software (302, 402, 502 and 602) to transmit segment 1, 2, 3 and 4 respectively. In some cases (such as, when such requested segment is not available), such source client software may reject such requests. In which case, such receiving client software may send requests to transmit such rejected segment to other such source client software.

Once such receiving client software (202) receives such requested segment data from particular transmitting source client software, such receiving client software will send a new request to such transmitting source client software to transmit either a new segment (next available sequential segment from unassigned section) or an expired segment (an assigned segment with insufficient transmission progress over certain period of time). The size of such requested segment may also be dynamically determined by such receiving client software (202) based on detected data transmission performance of such transmitting source client software. Such receiving client software (202) also appropriately updates such database server (101) and its local database with new data level to indicate new amount of data for such shared media file that can be served by such receiving client software as a data source to other client software. Such data streaming process described above may be performed until all content of such shared media file is received by such receiving client software.

For simplicity of explanation, such example above shows a data streaming process for a particular shared media file. Such receiving client software can also be configured to concurrently perform such data streaming processes for a number of shared media files. Such receiving client software (202) may continue to add such concurrent data streaming processes until certain data transmission conditions are reached. Such data transmission conditions can be based on limiting factors. Such limiting factors may include total data transmission rate (bytes/sec), average data transmission rate per peer-to-peer connection (byte/sec/connection), maximum number of peer-to-peer connections.

Another embodiment for such media file transmissions described above may include server system (100) that hosts computing devices to execute server-side client software. Such computing devices may run such server-side client software to provide data storage and network capacity to assist in transmissions of such shared media files to receiving client software. When such database server (101) receives a media sharing request, such database server (101) may automatically select particular server-side client software to receive such shared media files. Hence, peer-to-peer connections between such server-side client software and such source client software may be accordingly constructed using such process for constructing peer-to-peer connections described above.

Such server-side client software may receive contents of such shared media files from such source client software through such peer-to-peer connections in a manner described in such data streaming process above. By storing contents of such shared media files, such server-side client software may serve as source client software for data transmissions of such contents to associated receiving client software in a manner described in such data streaming process above. Such data transmissions between such server-side client software and such receiving client software may be performed through peer-to-peer connections that may be constructed using such process for constructing peer-to-peer connections described above. Such data transmissions between such server-side client software and such receiving client software may be performed even when other source client software (non server-side) are not available online. As described above, such server system (100) is designed for high availability system that is implemented with appropriate redundancies and hosted in reliable data centers. As a result, not only such alternative embodiment may assist in transmissions of such shared media files, but it may also increase availability of data sources for such shared media files.

Such server-side client software may decide to permanently store such shared media files or remove such stored media files when certain removing conditions are met. Such removing conditions may be based on available storage device capacities, amount time such media files have been stored, data transmission activities of such media files, number of source client software (non server-side) for such media files, statuses of user accounts, statuses of user's paid subscriptions and/or other cost related considerations.

The above description explains method, process, apparatus and system that allow peer-to-peer transmissions of shared media files among such client software. Such peer-to-peer media file transmissions can be performed over wide area network (WAN) or local area network (LAN). Next section describes capabilities to integrate such peer-to-peer media file transmissions with media delivery and rendering capabilities in a local area network.

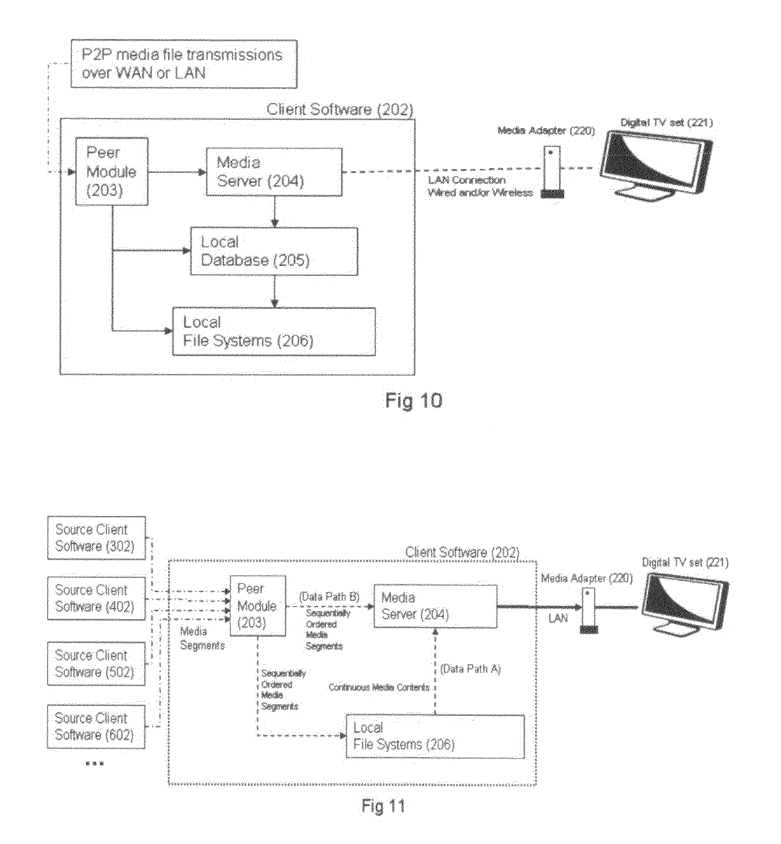

FIG. 10 shows a more detail diagram of client software (202). FIG. 10 shows peer module (203) that represents processing capabilities of such client software (202) that performs all tasks of such client software (202) in such peer-to-peer media file transmissions as described in previous sections. For example, such peer module (203) is responsible for constructions of peer-to-peer connections and performing data streaming processes as described above. Such peer module (203) may receive media contents from other source client software or send media contents to other receiving client software as described above.

FIG. 10 also shows media server (204) as part of client software (202). Such media server (204) has capabilities to distribute media files such as photos, videos and music to other network-enabled devices such as media adapter (220) in a local area network. Such media server (204) may implement standard data delivery protocols such as HTTP, TCP, UDP, UPnP, Jini and/or other protocols capable of transporting media files to facilitate distributions of such media files.

Local file systems (206) shown in FIG. 10 provide means for accessing and storing media files. Data storage locations for such media files are stored in such local database (205). Local file systems (206) may store existing local media files that are managed by such client software (202). Contents of shared media files that are received by such client software (202) through such peer-to-peer media file transmissions above may also be stored in such local file systems (206).

Data storage locations for such shared media files may be specified by user of such client software (202). In addition, such data storage locations for such shared media files may also be automatically determined by such client software (202) based on certain media information associated with such shared media files, in a manner described below. Such client software (202) may be configured to designate root directories for such automatically-determined data storage locations for such shared media files. Such client software (202) may also be configured to further designate root directories of additional storage devices to increase storage capacities if needed. Such client software (202) may further automatically determine subdirectories for such data storage locations for such shared media files based owner identification information and/or sender identification information of such shared media files. Such client software (202) may further automatically determine subdirectories for such data storage locations based on date information of sending, receiving or accepting of such media sharing requests for such shared media files. Such client software (202) may further automatically determine subdirectories for such data storage locations based on such sharing subjects of such media sharing requests for such shared media files. Such client software (202) may further automatically determine subdirectories for such data storage locations based on certain media group information such as play list information for such shared media files. An example for such data storage location that may be automatically determined by such client software (202) can be seen as following:

C:\documents\media root\John Smith\2006-05-15\Graduation Ceremony In such example, such automatically-determined data storage location is created based on a root directory (“C:\documents\media root”), owner identification information (“John Smith”), sending date of media sharing request (“2006-05-15”) and sharing subject (“Graduation Ceremony”) respectively. Such capabilities to automatically determine data storage locations for such shared media files allow for integrated and simplified user experience in receiving, managing and viewing such shared media files.

Local database (205) shown in FIG. 10 provides means for media information management for such client software (202). Such local database (205) manages media information for all media files including; existing local media files that are registered to such local database (205), and shared media files which peer module (203) is configured to receive from other source client software. Such media information may also include the amount of available data or data level associated with such all media files. Such data level information may also be used to track and display progresses of such peer-to-peer media file transmissions. Such media information may also include data storage locations for such all media files in such local file systems (206). Such media information may also include media properties of such all media files that may consist of owner identification information, media type information, title information, description, tag information, caption information and/or notes/comments.

Such client software (202) may have means to render local user interfaces in such computing device that executes such client software (202). Such local user interfaces provide means for a user to interact with such client software (202) using such computing device. FIG. 10 also shows a media adapter (220) that is connected to television set (221). As previously described, such media adapter (220) is capable of rendering user interfaces in such television set (221). Such media adapter (220) may also communicate with media server (204) to interact with such client software (202) over such local area network. Hence, such user interfaces that are rendered by such media adapter (220) in such television set (221) may be designed to allow a user to interact with such client software (202) over such local area network.

Whether using user interfaces in such computing device or in such television set (221), a user is able to interact with such client software (202). Such interactions may be conducted based on media information that are managed by such local database (205). A user may request such local database (205) to fetch media information of such media files that can be selected for rendering. Such local database (205) may then provide such media information of such media files that may include not only such local media files but also such shared media files which such peer module (203) is configured to receive using such peer-to-peer media transmissions. Such media information may also include data level information for such media files to indicate the amount of available media data that can be rendered. Such data level information for such shared media files also indicate the amount of media contents of such shared media files that have been received by such peer module (203). Such media information may also include media properties of such media files that may consist of owner identification information, media type information, title information, description, tag information, caption information and/or notes/comments. Such media properties may be dynamically received by such peer module (203) from such database server (101) over wide area network.

Such user interfaces may then display such requested media information hence a user would be able to browse, inspect and select media files to play or watch. Notes/comments from media owners and other media recipients that are parts of such dynamic media properties of such media files may be displayed in chronological order. Such media files selections may also indicate selections of rendering devices to render such media files. For example, a user may indicate such computing device and/or media adapter (220) as selected devices to render such selected media files. For simplicity of operations, the device that renders such user interface and is capable of rendering such selected media files may be selected as default device to render such media files.

Such client software (202) may receive such media files selections through such user interface means. Such client software (202) may then request such local database (205) for data storage locations and data level information associated with such media files selections. Such data level information indicate the amount of available media data of such media files selections that are stored in such local file systems (206) that can be continuously rendered. Such client software (202) may then facilitate rendering operations of such selected media files in such selected rendering devices.

Some media files from such media file selections may have complete data level (100% data level) such as locally registered media files or shared media files whose contents have been completely received in full by such peer module (203). In such case, such client software (202) would be able to access all media contents of such complete media files in such local file systems (206) using information of such data storage locations. Such client software (202) may then facilitate rendering operations of such media contents of such complete media files accordingly in such selected rendering devices. Such client software (202) may render such media contents of such complete media files in such computing device that executes such client software (202). Such client software (202) may also utilize such media server (204) to transmit such media contents of such complete media files to such media adapter (220). As such media contents of such complete media files are received by such media adapter (220); such media adapter (220) may render and display such media contents in such television set (221).

Some media files from such media file selections may have incomplete data level (less than 100% data level) such as shared media files whose contents have not been completely received by such peer module (203). In such case, client software (202) may analyze peer-to-peer media transmission processes that are executed by such peer module (203). Such client software (202) through its peer module (203) may prioritize peer-to-peer media transmission processes for such incomplete media files from such media file selections. As part of such prioritization capabilities, such peer module (203) may suspend or pause existing peer-to-peer media transmission processes for such other unselected media files. As part of such prioritization capabilities, such peer module (203) may reduce data transmission performances of such existing peer-to-peer media transmission processes for such other unselected media files. As part of such prioritization capabilities, such peer module (203) may remove such peer-to-peer connections with such source client software that are associated with such other unselected media files. As part of such prioritization capabilities, such peer module (203) may initiate new peer-to-peer media transmission processes for such incomplete media files from such media file selections. As part of such prioritization capabilities, such peer module (203) may increase data transmission performances of such peer-to-peer media transmission processes for such incomplete media files from such media file selections. As part of such prioritization capabilities, such peer module (203) may create peer-to-peer connections to new source client software for receiving media contents of such incomplete media files from such media file selections.

The above description explains such prioritization capabilities that are driven by such media file selections that may be made by a user as part of user interactions with such client software (202) in selecting media files to play or watch. Such client software (202) uses such prioritization capabilities to control and optimize peer-to-peer media transmission performances in receiving media contents of such selected media files. Hence, such client software (202) dynamically adapts such peer-to-peer media transmission processes based on demands for rendering such selected media files.

In addition to such on-demand prioritization capabilities, such client software (202) may also provide user with means to prioritize peer-to-peer media transmission processes for certain media files that are specified by such user. Such client software (202) may provide such user with means to specify media files for such prioritization based on media information of such media files. Such media information may include owner identification info, media type information, sender identification info and/or file identification info (registered fileID). Such media information may also include keywords or phrases that may be part of or represent title information, description, tag information, caption information and/or notes/comments. For example, such client software (202) may allow user to specify media files that are owned by “User A” and may contain the phrase “birthday event” in description information to prioritize peer-to-peer media transmission processes for such user-specified media files.

Such client software (202) may use such prioritization capabilities as described above to optimize such peer-to-peer media transmissions for such selected media files that have incomplete data level (less than 100% data level). Next section describes system and processes for rendering such incomplete media files during such peer-to-peer media transmissions.

As described previously, peer module (203) performs such peer-to-peer media transmissions. Such peer module (203) may receive media contents of an incomplete media file from a number of source client software in the manner described in media streaming process above. Segments of such media content from such multiple source client software may arrive at such peer module (203) at different times. Such peer module (203) may temporarily store such media segments in its buffer memory for the purpose of sequentially ordering such media segments. Such peer module (203) may then permanently store such sequentially-ordered media segments as part of continuous media content of such incomplete media file in such local files systems (206). Such continuous media content of such incomplete media file allows such rendering operations of such media content to be continuously performed without interruptions for the duration of such continuous media content.

Such client software (202) may facilitate rendering operations for such accordingly selected rendering devices to render media contents of such incomplete media files. Consequently, such client software (202) may render such media contents of such incomplete media files in such computing device that executes such client software (202). Such client software (202) may also utilize such media server (204) to transmit such media contents of such incomplete media files to such media adapter (220). As such media contents of such incomplete media files are received by such media adapter (220); such media adapter (220) may continuously render and display such media contents in such television set (221).

As explained above, such local file systems (206) may store such continuous media contents that are part of such incomplete media files. Such rendering operations above may obtain media contents that are available in such continuous media contents for rendering parts of such incomplete media files. To render media contents that are not yet available in such continuous media contents, such rendering operations may request such peer module (203) to distribute to such rendering operations newly received media contents whose segments have been sequentially ordered by such peer module (203). Consequently, such peer module (203) may distribute such newly received media contents to rendering operations of such client software (202) to render such newly received media contents of such incomplete media files in such computing device. Such peer module (203) may also distribute such newly received media contents to such media server (204) to transmit such newly received media contents of such incomplete media files to such media adapter (220) over a local area network. As such newly received media contents of such incomplete media files are received by such media adapter (220); such media adapter (220) may render and display such media contents in such television set (221).

The above description explains a system with rendering operations that can be supplied with two possible data sources namely: such continuous media contents stored in such local file systems (206) and such newly received media contents whose segments have been sequentially ordered by such peer module (203). Such rendering operations whether performed by such computing device or by such media adapter (220) through such media server (204), have capabilities to seamlessly render entire media contents of such incomplete media files while media contents of such incomplete media files are being received by such peer module (203) through such media streaming processes using such peer-to-peer media transmissions.

FIG. 11 shows a system that integrates such peer-to-peer media transmissions with such rendering operations. Although FIG. 11 shows rendering operations that are performed by such media adapter (220) through such media server (204); such rendering operations may also be performed by such computing device that executes such client software (202). In such a case, media transmitting capabilities of such media server (204) and rendering operations of such media adapter (220) as shown in FIG. 11 may be replaced with rendering operations of such client software (202) to locally render such media contents in such computing device that executes such client software (202).

As shown in FIG. 11, such peer module (203) may receive media segments through such media streaming processes from such multiple source client software using such peer-to-peer media transmissions as described in earlier sections. Although such media segments in such media streaming processes are sequentially chosen in the manner to allow data streaming, such media segments may arrive at such peer module (203) at different times. Such peer module (203) may temporarily store such media segments in its buffer memory for the purpose of sequentially ordering such media segments.

As shown in FIG. 11, the results of such ordering operations performed by such peer module (203) are in the forms of sequentially ordered media segments. Such peer module (203) stores such sequentially ordered media segments in such local file systems (206) as parts of such continuous media contents of such media files. Such media server (204) may then access such local file systems (206) to obtain media contents that are parts of such continuous media contents, shown as “Data Path A” in FIG. 11. Such media server (204) may then transmit such media contents that are received through such “Data Path A” to such media adapter (220) that may render and display such media contents in such television set (221).

FIG. 11 also shows media server (204) that is capable of receiving results of such ordering operations performed by such peer module (203) in the forms of sequentially ordered media segments. Such receiving capability of such media server (204) as described above is shown as “Data Path B” in FIG. 11. Such media server (204) may then transmit such sequentially ordered media segments that are received through such “Data Path B” to such media adapter (220) that may render and display such media content in such television set (221).

Such media server (204) may select to receive media contents from such peer module (203) through such “Data Path B” to obtain new media segments that are being transmitted through such peer-to-peer media transmissions. Such new media segments may not be yet parts of such continuous media contents stored in such local file systems (206). Such media server (204) may request such peer module (203) to distribute to such media server (204) newly received media contents whose segments have been sequentially ordered by such peer module (203).

Depending on availability of such media contents, such media server (204) is capable of dynamically obtaining associated media contents from two sources namely: such continuous media contents (Data Path A) from such local file systems (206) or such new sequentially ordered media segments (Data Path B) from such peer module (203). Such dynamic media content obtaining capability allows such media server (204) to continuously serve such media contents to such media adapter (220) while new media segments of such media contents are being received by such peer module (203) through such peer-to-peer media transmissions. As such media adapter (220) receives such media contents; such media adapter (220) may then also continuously render and display such media contents in such television set (221). Consequently, such system as shown in FIG. 11 may seamlessly integrate peer-to-peer media transmissions over wide area network with media serving and rendering operations over local area network.

Next sections describes means of presenting, navigating and searching media files that are locally registered as well as media files that are received through such peer-to-peer media sharing, transmissions and distributions described in previous sections.

As previously described, such database server (101) manages media properties of registered media files. Such registered media file may constitute a parent media file or a derivative media file. Through relational information of parent fileID, such database server (101) may designate the same set of such media properties for a parent media file and all derivative media files from such parent media file. Such media properties may include owner identification information, media type information, title information, description, tag information, caption information and/or notes/comments. Such database server (101) may distribute such media properties of such registered media file to such file owner and all users who accept media sharing requests for such registered media file. Distributions of such media properties of such registered media file are facilitated by such database server (101) to such authorized recipients upon creations, additions, modifications and/or deletions of such media properties. Hence, such distributions of such media properties of such registered media file may be dynamically received by such authorized client software (202) that includes: such client software (202) where such registered media file is first locally registered (also known as owner client software) and such client software (202) that are owned and designated by such users who are parts of such authorized recipients of such media sharing requests to receive such registered media file.

Such client software (202) utilizes such local database (205) to manage such media properties that are associated with such media files. In addition, as previously described, such local database (205) may also manage information related to media sharing requests for such media files, which includes date information of sending, receiving or accepting of such media sharing requests as well as sender identification information, recipient identification information, sharing subjects and sharing messages of such media sharing requests. As a result, organizational structures for such media files may be presented to users using categorizations that are defined based on such media properties and/or such information related to such media sharing requests. Such local database (205) may provide data processing means to categorize such media files based on relational database queries that are defined using such media properties and/or such information related to such media sharing requests. In addition, such organizational structures may also include conventional categorizations that may partly or wholly emulate or represent directory structures of data storage locations of such media files in such local file systems (206).

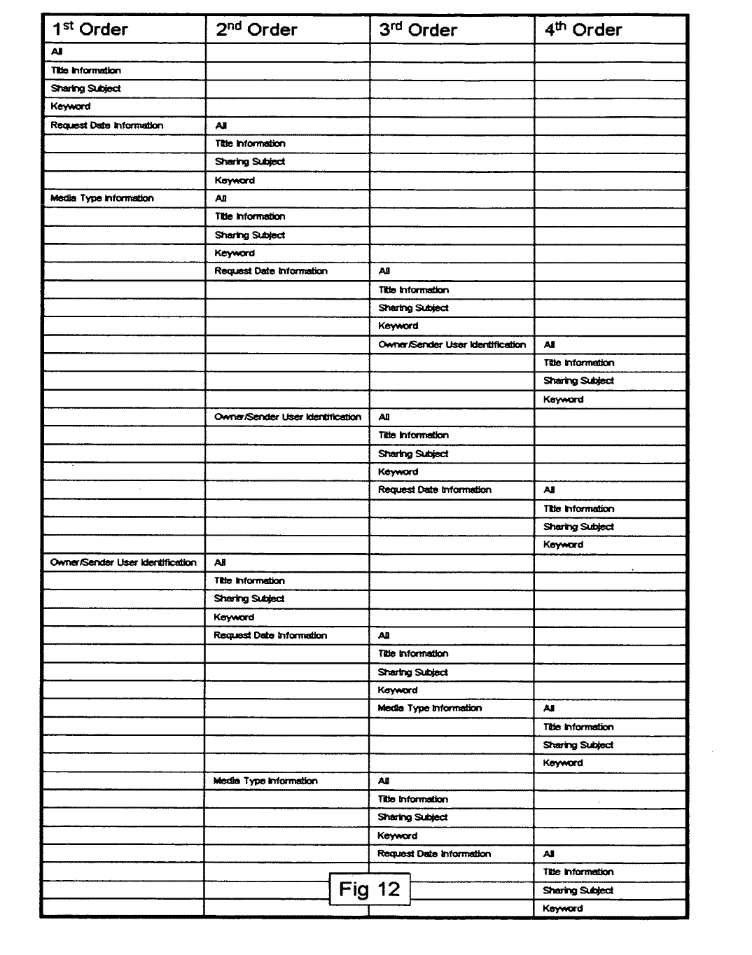

FIG. 12 shows possible categorizations of such media files that are facilitated by such data processing means of such local database (205). Such categorizations may be presented to users in multi-stage or multi-order operations to allow for effective navigations in locating such media files.

For the purpose of description, an example case below explains such categorizations shown in FIG. 12 that uses media type information as the 1^{st} order categorization. Other categorizations in FIG. 12 can also be operated in the same manner. In such an example case, users are first presented with media type information that may include video, photo and/or music. Hence in such 1^{st} order categorization, a user may select the type of media that he or she would like to play or watch. For example, such user may select video category and proceed to 2^{nd} order categorization.

In such 2^{nd} order categorization, user may further select a number of categorizations to further categorize such all video media files. Such 2^{nd} order categorizations may include All, Title Information, Sharing Subject, Keyword, Request Date Information and/or Owner/Sender User Identification.

Such All category (2^{nd} order) presents to such user all media files to select from that have been categorized so far. Hence, in this example such user may be presented with all video media files. Such all video media files may be sorted alphabetically based on their file names.

Such Title Information category (2^{nd} order) presents to such user all media files to select from that have been categorized so far. Hence, in this example such user may be presented with all video media files. Such all video media files may be sorted alphabetically based on their title information.

Such Sharing Subject category (2^{nd} order) presents to such user sharing subjects of media sharing requests. In this example, such user may select a particular sharing subject of media sharing request. Such user may further be presented with video media files that are parts of such selected media sharing request.

Such Keyword category (2^{nd} order) presents to such user with keywords or phrases that are associated with such media files. Such keywords or phrases may be extracted from information associated with such media files, including owner identification information, sender identification information, recipient identification information, title information, description, tag information, caption information, notes/comments, sharing subjects or/and sharing messages. Such keywords or phrases may be sorted alphabetically. In this example, a user may select a particular keyword category such as “grand canyon vacation”. Such user may further be presented with video media files that contain such keyword category in such information associated with such media files. Such user may also be further presented with additional categorizations (not shown in FIG. 12) including all, title information, sharing subject, request date information and/or owner/sender user identification.

Such Request Date Information category (2^{nd} order) presents to such user with date information of media sharing requests associated with such media files. Such date information may include sending, receiving or accepting dates for such media sharing requests. For local media files (non-shared), date information associated with creations or last modifications of such local media files may be used. Such date information for such local media files may be specified in such local media files or, explicitly or implicitly specified by such media owners or other authorized users in such local database (205). Such date information may be sorted chronologically. In this example, such user may select particular request date information. Such user may be presented with 3^{rd} order categorization for such video media files that are associated with such selected request date information. Such 3^{rd} order categorizations of All, Title Information, Sharing Subject and Keyword operate as described above on such video media files that are associated with such selected request date information. Such 3^{rd} order categorizations of Owner/Sender User Identification may present such user with owner and/or sender user identification associated with such media files. Such owner/sender user identification category may be presented to such user in the forms of first name, last name, full name, user name, alias or other names that can identify a user. Such owner/sender user identification category may be sorted alphabetically. In this example, such user may select particular owner/sender user identification such as “John Smith”. Such user may be presented with such 4th order categorizations for such video media files that are associated with such selected request date information and owned or sent by “John Smith”. Such 4th order categorizations of All, Title Information, Sharing Subject and Keyword operate as described above on such video media files that are associated with such selected request date information and owned or sent by “John Smith”.

Such Owner/Sender User Identification category (2^{nd} order) presents to such user with owner and/or sender user identification associated with such media files. Such owner/sender user identification category may be presented to such user in the forms of first name, last name, full name, user name, alias or other names that can identify a user. Such owner/sender user identification category may be sorted alphabetically. In this example, such user may select particular owner/sender user identification such as “John Smith”. Such user may be presented with 3^{rd} order categorizations for such video media files that are owned or sent by “John Smith”. Such 3^{rd} order categorizations of All, Title Information, Sharing Subject and Keyword operate as described above on such video media files that are owned or sent by “John Smith”. Such 3^{th} order categorizations of Request Date Information also operate as described above on such video media files that are owned or sent by “John Smith”. In this example, such user may select particular request date information. Such user may be presented with 4th^{rd} order categorizations for such video media files that are owned or sent by “John Smith” and associated with such selected request date information. Such 4^{th} order categorizations of All, Title Information, Sharing Subject and Keyword operate as described above on such video media files that are owned or sent by “John Smith” and associated with such selected request date information.

The names of categories used in such categorizations shown in FIG. 12 may be substituted with other names that may convey similar functional or operational meanings. Such categorizations shown in FIG. 12 only present parts of all possible categorizations for explanation purposes. Other categorizations may also be constructed in the same manner as described above based on such media properties and peer-to-peer media sharing information that are managed by such data processing means of such local database (205). In addition to category-based navigations as described above, a general search mechanism may also be provided based on keyword search. Such local database (205) may manage keywords or phrases that are related to such with media files. Such keywords or phrases may be extracted from information associated with such media files, including owner identification information, sender identification information, recipient identification information, title information, description, tag information, caption information, notes/comments, sharing subjects or/and sharing messages. Such user may submit a keyword or a phrase that may contain a number of words to search for such media files in such client software (202). Such submitted keyword or phrase may be used by such local database (205) to search for media files that contain such keyword or phrase in such information associated with such media files. For example, such user may submit a phrase such as “grand canyon vacation”. Such user may then be presented with media files that contain such phrase in such information associated with such media files. The results of such search operations may be presented to such user in the orders of closest search match, media preference/favorite ratings, media type information and/or media selection frequencies.

The sections above describes means of presenting, navigating and searching media files that are locally registered as well as media files that are received through such peer-to-peer media sharing, transmissions and distributions. A user may be provided with such means of presenting, navigating and searching through user interfaces that are rendered by such computing device that execute such client software (202). Furthermore, such user may also be provided with such means of presenting, navigating and searching through user interfaces that are rendered by such media adapter (220) in such television set (221). Such media adapter (220) may communicate with such media server (204) to access such data processing means of such local database (205) over such local area network. Hence, such user is capable of interacting with such means of presenting, navigating and searching through such media adapter (220) that may communicate to such media server (204). Therefore, such media adapter (220) may render such user interfaces in such television set (221) to present such categorizations of such media files or such general search capabilities that allow such user to navigate, browse and/or search such media files. Such means of presenting, navigating and searching may be dynamically constructed based on such media sharing requests for such peer-to-peer media transmissions and such media properties of such shared media files that may be dynamically received by such client software (202) over wide area network. The above description explains system and processes that integrate such peer-to-peer media sharing, transmissions and distributions over wide area network with such means of presenting, navigating and searching over local area network.

The embodiments of the invention in which an exclusive property or privilege is claimed are defined as follows:

1. A system for peer-to-peer media delivery comprising:
media sender that defines media sharing request by specifying selected media receivers and selected media files,
plurality of such media receivers each capable of accepting such media sharing request by specifying receiver devices to be authorized to receive such selected media files,
peer-to-peer network connections over wide area network constructed for multi-source data transmissions between sender devices and receiver devices that comply with agreement between such media sharing request by such media sender and such media sharing acceptances by such media receivers and,
processing means which centrally authenticate such media sender and such media receivers, and such processing means provide central authorization means for such media sharing request.

2. A system of claim 1 wherein such sender device has means of media capturing capabilities to acquire media files from image capturing devices.

3. A system of claim 1 wherein such receiver device has means of transferring such selected media files to portable media players and, such portable media players have processing means to render such selected media files.

4. A system of claim 3 wherein such receiver device has means to reduce sizes of such selected media files to accommodate processing capacities of such portable media players.

5. A system of claim 1, wherein such receiver device is built into television set.

6. A system of claim 1, wherein such media receiver is capable of submitting media sharing acceptance of such media sharing request to such processing means over wide area network, such media sharing acceptance specifies receiver devices to be authorized to receive such selected media files.

7. A system of claim 6, wherein such receiver devices have means to receive data of such selected media files using such peer-to-peer network connections with such sender devices over wide area network, such receiver devices further have data storage means to store such received data of such selected media files.

8. A system of claim 7, wherein such storage means are capable of automatically selecting data storage locations for such selected media files, where such storage means are configured to designate certain root directories for such automatically selected data storage locations for such selected media files.

9. A system of claim 8, wherein such storage means are capable of automatically selecting relative data storage locations for such selected media files based on media properties of such selected media files that include combinations of owner identification information, sender identification information, media type information, title information, media sharing request date, sharing subject information, or play list information.

10. A system of claim 6, wherein such processing means are capable of configuring such authorized receiver devices to start using such peer-to-peer network connections with such sender devices over wide area network to receive such selected media files.

11. A system of claim 6, wherein such receiver devices have selecting means to prioritize such peer-to-peer network connections with such sender devices which are geographically closer to such receiver devices.

12. A system of claim 6, wherein such receiver devices have selecting means to prioritize such peer-to-peer network connections with such sender devices which have the same network service providers with such receiver devices.

13. A system of claim 6, wherein such receiver devices have selecting means to prioritize such peer-to-peer network connections with such sender devices which provide data transmissions for such selected media files which are currently being rendered.

14. A system of claim 6, wherein such receiver devices have selecting means to prioritize such peer-to-peer network connections with such sender devices which provide data transmissions for certain selected media files, where such receiver devices are configured to prioritize data transmissions for such certain selected media files which have certain media properties that include combinations of owner identification info, media type information, sender identification info, file identification info, title information, description, tag information, caption information, notes or comments.

15. A system of claim 6, wherein such receiver devices have limiting means to regulate utilization of such peer-to-peer network connections with such sender devices in receiving such selected media files.

16. A system of claim 15, wherein such limiting means are restricted on total data transmission rate.

17. A system of claim 15, wherein such limiting means are restricted on average data transmission rate per such peer-to-peer connection.

18. A system of claim 15, wherein such limiting means are restricted on maximum number of such peer-to-peer connections.

19. A system of claim 6, wherein such receiver device has means to receive data of such selected media files using such peer-to-peer network connections with plurality of sender devices in a manner that allows continuous rendering of such received media data while such peer-to-peer data transmissions are being performed.

20. A system of claim 1, wherein such processing means can be configured by such media receivers to automatically authorize receiver devices to receive such selected media files based on data characteristics of such selected media files.

21. A system of claim 20, wherein such data characteristics of such selected media files include combinations of media sender information, media type information, data sizes, title, caption, tag information, description, notes, comments, geographic location information or media capture device type.

22. A system of claim 1, further comprising assistant devices which have means to receive and store data of such selected media files for the purpose of assisting in data transmissions of such selected media files to authorized receiver devices in a manner that complies with such agreement between such media sharing request by such media sender and such media sharing acceptances by such media receivers.

23. A system of claim 22, wherein such assistant devices have means to remove data of such stored media files from such data storage means based on certain limiting conditions that include combinations of available data storage capacities, amount of time such media files have been stored, data transmission activities of such media files, number of sender devices for such media files, statuses of user accounts or statuses of user's paid subscriptions.

24. A system of claim 1, wherein such receiver device is capable of providing means of categorizations for the purpose of navigating and browsing such selected media files, such means of categorizations further allow multi-order navigations to locate such selected media files.

25. A system of claim 24, wherein such means of categorizations provide multi-order organizational structures based on media properties of such selected media files that include combinations of owner identification information, sender identification information, media type information, media date information, title information, media sharing request date, sharing subject information, or play list information.

26. A system of claim 25, wherein such means of categorizations provide multi-order organizational structures based on media properties of such selected media files where owner identification information of such selected media files is presented as first order category.

27. A system of claim 26, wherein such owner identification information is presented in alphabetical order that includes combinations of first name, last name, full name, user name, or alias.

28. A system of claim 25, wherein such means of categorizations provide multi-order organizational structures based on media properties of such selected media files where sender identification information of such selected media files is presented as first order category.

29. A system of claim 28, wherein such sender identification information is presented in alphabetical order that includes combinations of first name, last name, full name, user name, or alias.

30. A system of claim 25, wherein such means of categorizations provide multi-order organizational structures based on media properties of such selected media files where media date information of such selected media files is presented as first order category.

31. A system of claim 30, wherein such media date information is presented in chronological order.

32. A system of claim 25, wherein such means of categorizations provide multi-order organizational structures based on media properties of such selected media files where media type information of such selected media files is presented as first order category.

33. A system of claim 1, wherein such receiver device is capable of providing means of searching using keywords or phrases to locate such selected media files.

34. A system of claim 33, wherein such means of searching locate such selected media files using such keywords or phrases which are contained in media information of such selected media files, such media information of such selected media files includes combinations of owner identification information, sender identification information, recipient identification information, title information, description, tag information, caption information, notes, comments, sharing subjects or sharing messages.

35. A system of claim 33, wherein such means of searching provide search results of such selected media files in the orders of combinations of closest search match, media preference ratings, media type information or media selection frequencies.

36. A system for peer-to-peer media delivery comprising:
media sender that defines media sharing request by specifying selected media receivers and selected media files,
plurality of such media receivers each capable of accepting such media sharing request by specifying receiver devices to be authorized to receive such selected media files,
peer-to-peer network connections over wide area network constructed for multi-source data transmissions between sender devices and receiver devices that comply with agreement between such media sharing request by such media sender and such media sharing acceptances by such media receivers and,
such receiver device has means of media server capabilities to provide means of distributing data of such selected media files over local area network.

37. A system of claim 36 wherein such sender device has means of media capturing capabilities to acquire media files from image capturing devices.

38. A system of claim 36 wherein such receiver device has means of transferring such selected media files to portable media players and, such portable media players have processing means to render such selected media files.

39. A system of claim 38 wherein such receiver device has means to reduce sizes of such selected media files to accommodate processing capacities of such portable media players.

40. A system of claim 36 further comprising media adapter that has means for receiving data of such selected media files from such media server capabilities of such receiver device over such local area network, such media adapter also has means for displaying such selected media files in television set.

41. A system of claim 40, wherein such receiver device has means to receive data of such selected media files using such peer-to-peer network connections with plurality of sender devices in a manner that allows such media server capabilities to distribute data of such selected media files to such media adapter for continuous rendering of such received media data while such peer-to-peer data transmissions are being performed.

42. A system of claim 40, wherein such media adapter means are built into such television set.

43. A system of claim 40, wherein such media adapter has means for storing such selected media files in data storage means, and such media adapter also has means for rendering such selected media files from such data storage means.

44. A system of claim 43, wherein such media adapter means are built into such television set.

45. A system of claim 36, wherein such receiver device is capable of providing means of categorizations for the purpose of navigating and browsing such selected media files, such means of categorizations further allow multi-order navigations to locate such selected media files.

46. A system of claim 45, wherein such means of categorizations provide multi-order organizational structures based on media properties of such selected media files that include combinations of owner identification information, sender identification information, media type information, media date information, title information, media sharing request date, sharing subject information, or play list information.

47. A system of claim 46, wherein such means of categorizations provide multi-order organizational structures based on media properties of such selected media files where owner identification information of such selected media files is presented as first order category.

48. A system of claim 47, wherein such owner identification information is presented in alphabetical order that includes combinations of first name, last name, full name, user name, or alias.

49. A system of claim 46, wherein such means of categorizations provide multi-order organizational structures based on media properties of such selected media files where sender identification information of such selected media files is presented as first order category.

50. A system of claim 49, wherein such sender identification information is presented in alphabetical order that includes combinations of first name, last name, full name, user name, or alias.

51. A system of claim 46, wherein such means of categorizations provide multi-order organizational structures based on media properties of such selected media files where media date information of such selected media files is presented as first order category.

52. A system of claim 51, wherein such media date information is presented in chronological order.

53. A system of claim 46, wherein such means of categorizations provide multi-order organizational structures based on media properties of such selected media files where media type information of such selected media files is presented as first order category.

54. A system of claim 36, wherein such receiver device is capable of providing means of searching using keywords or phrases to locate such selected media files.

55. A system of claim 54, wherein such means of searching locate such selected media files using such keywords or phrases which are contained in media information of such selected media files, such media information of such selected media files includes combinations of owner identification information, sender identification information, recipient identification information, title information, description, tag information, caption information, notes, comments, sharing subjects or sharing messages.

56. A system of claim 54, wherein such means of searching provide search results of such selected media files in the orders of combinations of closest search match, media preference ratings, media type information or media selection frequencies.

57. A system for peer-to-peer media delivery comprising:
media sender that defines media sharing request by specifying selected media receivers and selected media files,
plurality of such media receivers each capable of accepting such media sharing request by specifying receiver devices to be authorized to receive such selected media files,
peer-to-peer network connections over wide area network constructed for multi-source data transmissions between sender devices and receiver devices that comply with agreement between such media sharing request by such media sender and such media sharing acceptances by such media receivers and,
processing means which store and distribute submissions or modifications of media properties of such selected media files for such sender devices and such receiver devices.

58. A system of claim 57, wherein such media properties of such selected media files include combinations of title information, media date information, description, tag information, caption information, notes or comments.
